(19) United States
(12) Patent Application Publication
(10) Pub. No.: US 2024/0343579 A1
(43) Pub. Date: Oct. 17, 2024

(54) POWDER OF SOLID MATERIAL PARTICLES COMPRISING AT LEAST LI, P AND S ELEMENTS

(71) Applicant: SPECIALTY OPERATIONS FRANCE, Lyon (FR)

(72) Inventors: Lauriane D'Alencon, Issy-Les-Moulineaux (FR); Diego Lopez Gonzalez, Puteaux (FR); Jules Valente, Paris (FR); Thierry Le Mercier, Rosny-sous-Bois (FR)

(73) Assignee: SPECIALTY OPERATIONS FRANCE, Lyon (FR)

(21) Appl. No.: 18/293,744

(22) PCT Filed: Aug. 1, 2022
(86) PCT No.: PCT/EP2022/071590

§ 371 Date: Jan. 30, 2024

(30) Foreign Application Priority Data
Aug. 2, 2021 (EP) 21315135.0

(51) Int. Cl. C01B 25/14; H01M 10/0562

(52) U.S. Cl. CPC C01B 25/14; H01M 10/0562; C01P 2002/82; C01P 2004/51; C01P 2004/61; C01P 2006/40; H01M 2300/008

(57) ABSTRACT

The present disclosure relates to The present disclosure relates to a powder of solid material particles comprising at least Li, P and S elements, characterized in that the thiol to carbonate surface groups ratio of the particle surface is less than 2, as measured by diffuse reflectance infrared Fourier transform spectroscopy (DRIFTS) on a Bruker FTIR (MIR) Vertex 70 spectrometer. The present disclosure also relates to a process for preparing such powder, as well as to the use of such powder for notably manufacturing solid electrolytes or battery articles.

### TECHNICAL FIELD

This application claims priority filed on 2 Aug. 2021 in EUROPE with Nr 21315135.0, the whole content of this application being incorporated herein by reference for all purposes.

The present disclosure relates to a powder of solid material particles comprising at least Li, P and S elements, characterized in that the thiol to carbonate surface groups ratio of the particle surface is less than 2, as measured by diffuse reflectance infrared Fourier transform spectroscopy (DRIFTS) on a Bruker FTIR (MIR) Vertex 70 spectrometer. The present disclosure also relates to a process for preparing such powder, as well as to the use of such powder for notably manufacturing solid electrolytes or battery articles.

### BACKGROUND

Lithium ion batteries are widely used as power supplies notably for appliances. In such secondary batteries, an organic solvent is used as an organic liquid electrolyte and lithium ions migrate from one electrode to the other, depending on whether the battery is charging or discharging.

Because the solvent used as an electrolyte is flammable, all-solid-state lithium ion battery not using organic solvent are very attractive. Such all-solid-state lithium ion batteries are formed by solidifying the whole battery using components which are all solid, that-is-to-say the cathode, the anode and the electrolyte. Because all the components of the solid-state battery are solid, including the electrolyte, all-solid-state battery have a large electrical resistance and provide a small output current, in comparison to a battery using a liquid electrolyte. This means that there is a need for electrolytes having a high conductivity, as well as an aptitude to maintain this high conductivity over time.

It is known that the surface groups determine specific performance parameters of the solid-electrolyte materials, notably their conductivity. It is also generally known that the material surface is capable of being modified when it is in contact with the moisture and the CO₂ present in the atmosphere, which leads to a modification of the conductivity at the interface of the solid. For example, sulfur atoms in such materials tend to react with the moisture in the air to generate hydrogen sulfide, which is not desired.

An object of the present invention is to provide an electrolyte presenting a high conductivity and resistance to ageing, including aptitude to maintain such high conductivity over time, without compromising other key properties like chemical and mechanical stability and at the same time, generating as less hydrogen sulfide as possible.

### SUMMARY

The present invention relates to a powder of solid material particles comprising at least Li, P and S elements, characterized in that the thiol to carbonate surface groups ratio of the particle surface is less than 2, as measured by diffuse reflectance infrared Fourier transform spectroscopy (DRIFTS) on a Bruker FTIR (MIR) Vertex 70 spectrometer (25° C., atmospheric pressure, 25 Nml/min Argon flow).

In some embodiments, the solid material is according to formula (I):

LiₐPS_{b}X_{c} (1)
wherein
   X represents at least one halogen element;
   a represents a number from 2.0 to 7.0;
   b represents a number from 3.5 to 6.0; and
   c represents a number from 0 to 3.0.

In some embodiments, the solid material is according to formula (II):

Li₇₋ₓPS₆₋ₓXₓ (II)
wherein:
   X represents at least one halogen element selected in the group of F, Cl, Br and I or a combination thereof; and
   x represents a positive number from 0.5 to 2.0.

The solid material is preferably Li₆PS₅Cl, Li₄P₂S₆, Li₇PS₆, Li₇P₃S₁₁ or Li₃PS₄.

The present invention also relates to a method for producing the powder of the present invention, comprising the steps of:
a) mixing the starting materials, optionally with high energy, to obtain a paste in a slurry state,
b) drying the paste from step a),
b′) optionally pressing the dried paste from step b) into pellets, and
c) heating the dried paste, e.g. in the form of pellets, to a temperature comprised between 350° C. and 580° C. for a time period of at least 2 hours, for example 4 hours, 6 hours, 8 hours, 10 hours or 12 hours.

The present invention also relates to the use of the powder of the present invention to manufacture a solid electrolyte, to a solid electrolyte comprising at least such powder, to an electrochemical device comprising at least such solid electrolyte, to a solid state battery comprising at least such solid electrolyte, and to an electrode or a battery separator comprising at least such powder.

### DISCLOSURE OF THE INVENTION

In the present application:
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

The present invention relates to a solid electrolyte material presenting a ratio of thiol surface groups to carbonate surface groups less than 2.0, as measured by diffuse reflectance infrared Fourier transform spectroscopy (DRIFTS) on a Bruker FTIR (MIR) Vertex 70 spectrometer (25° C., atmospheric pressure, 25 Nml/min Argon flow). The ratio between the considered groups is calculated by taking into consideration the maximum intensity peak in the relevant spectral region i.e. taking into consideration the maximum intensity peak in the 2400 cm⁻¹ to 2570 cm⁻¹ region for the thiol group and in the 1370 cm⁻¹ to 1570 cm⁻¹ region for the carbonate group. The inventors hereby show that a material presenting such a specific ratio thiol/carbonate surface groups makes the material not only highly conductive in comparison to materials with thiol to carbonate surface groups more than 2.0, but it also presents an improved resistance to ageing, as measured by its conductivity change and weight change over time. The inventors indeed show that the ratio to carbonate groups in fact provides an improved compromise between the conductivity of the material and its resistance to ageing, which makes the material of the present invention well-suited to be used in the preparation of all-solid-state lithium ion batteries.

The powder of solid material particles of the present invention comprises at least Li, P and S elements. In some embodiments, the solid material is according to formula (I):

LiₐPS_{b}X_{c} (1)
wherein
   X represents at least one halogen element;
   a represents a number from 2.0 to 7.0, for example from 3.0 to 6.0, from 4.0 to 6.0 or from 5.0 to 6.0;
   b represents a number from 3.5 to 5.0, for example from 3.9 to 5.0 or from 4.1 to 5.0; and
   c represents a number from 0 to 3.0, for example from 0.9 to 2.9 or from 1.0 to 2.5.

According to formula (I), c may be equal to zero. In this case, the solid material does not comprise any halogen component and the solid material is according to formula (I′):

LiₐPS_{b} (I′)
wherein
   a represents a number from 2.0 to 7.0, for example from 3.0 to 7.0; and
   b represents a number from 3.5 to 5.0, for example from 3.9 to 4.9 or from 4.0 to 4.5.

According to formula (I), c may be from 0.9 to 1.1. In this case, the solid material may be according to formula (I″):

LiₐPS_{b}X_{c′}(I″)
wherein
   c′ represents a number from 0.9 to 1.1, for example equals 1.0.

According to this formula (I″), X is preferably Cl. In this case, formula (I″) is as follows:

LiₐPS_{b}Cl_{c′}(I″)

In some embodiments, the solid material is according to formula (II):

L₇₋ₓPS₆₋ₓXₓ (II)
wherein:
   X represents at least one halogen element selected in the group of F, Cl, Br and I or a combination thereof; and
   x represents a positive number from 0.5 to 2.0.

According to these embodiments:
x may more particularly vary between 0.8 and 1.8; x may for instance be equal to 1.0 or to 1.5; x may also vary between 0.95 and 1.05 or between 1.45 and 1.55; and/or
X is more particularly Cl, Br or a combination thereof; X may also be more particularly Cl.

In some preferred embodiments, the solid material is Li₆PS₅Cl, Li₄P₂S₆, Li₇PS₆, Li₇P₃S₁₁ or Li₃PS₄, more preferably Li₆PS₅Cl or Li₃PS₄.

Formulas of the solid material described in the present disclosure may be determined according to well-known analytical techniques.

In the present invention, the solid material as characterized by its formula, herein formula (I) or (II), may be the major constituent of the powder. The proportion of this solid material may be at least 60 wt. %, at least 70 wt. %, at least 80 wt. %, at least 90 wt. %, at least 95 wt. % or even at least 98 wt. % or 99 wt. %, based on the total weight of the powder.

The powder may also for example comprise an amorphous phase, and the starting materials used to prepare the powder, for example LiX (X being a halogen, for example Cl), Li₂S, phosphorus sulfide (e.g. P₂S₅), and/or Li₃PO₄.

The powder may also be characterized by its size or Particle Size Distribution (PSD). The size of the particles of the powder may be such that it presents:
a d₅₀-value of less than 50 μm, for example less than 40 μm, less than 30 μm or less than 20 μm,
a d₁₀-value higher than 0.05 μm, and/or
a d₉₀-value of less than 100 μm, for example less than 90 μm, less than 80 μm or less than 70 μm,
as measured by laser diffraction in para-xylene.

The powder may be constituted of particles which are aggregated.

The d₅₀-value corresponds to the median of a distribution in number of the diameters of the particles. The measurement of the particle size distribution (PSD), e.g. d₅₀-value, d₁₀-value and d₉₀-value, may be performed with a scanning electronic microscope (SEM) on a number of particles, which is at least 150. Alternatively, it may be performed by laser diffraction in para-xylene.

The particles of the powder may be spheroidal in shape.

The particles of the powder may exhibit a sphericity ratio SR between 0.8 and 1.0, more particularly between 0.85 and 1.0, even more particularly between 0.90 and 1.0. SR may preferably be between 0.90 and 1.0 or between 0.95 and 1.0. The sphericity ratio of a particle is calculated from the measured perimeter P and area A of the projection of the particle using the following equation:

$$SR = 4 π A / {P}^{2}$$

For an ideal sphere, SR is 1.0 and it is below 1.0 for spheroidal particles. The SR may be determined by a Dynamic Image Analysis (DIA). An example of appliance that can be used to perform the DIA is the CAMSIZER®P4 of Retsch or the QicPic® of Sympatec. The sphericity ratio may be more particularly measured according to ISO 13322-2 (2006). The DIA generally requires the analysis of a large number of particles to be statistically meaningful (e.g. at least 500 or even at least 1000).

The powder of the present invention may also be characterized by a low emission of H₂S in given conditions. This feature may be measured by exposing the powder to a humid atmosphere and by measuring the quantity of H₂S released during the first 50 minutes at which the powder is in contact with said atmosphere. For example, when the powder of the present invention is exposed for 50 minutes to an atmosphere composed of humid air with a relative humidity of 35%, the release r of H₂S may preferably be lower than 70 mL/g, the measurement being performed at a temperature of 23° C. Under the same experimental conditions, it is also possible to determine the rate of emission of H₂S in mL H₂S/g/h. This rate may for example be lower than 84 mL H₂S/g/h for the powder of the present invention.

The crystalline phase of the powder (which corresponds to the cubic crystal structure belonging to space group F −4 3 m) may be assessed by X-ray diffractometry (XRD), using Cu radiation source.

The powder may advantageously exhibit an ionic conductivity of at least 1.5 mS/cm, for example at least 1.7 mS/cm, or between 1.9 and 5.0 mS/cm, as measured on pressed (500 MPa) pellets by impedance spectroscopy at 25° C., for example an ionic conductivity between 2.0 and 4.5 mS/cm.

The measurement of the ionic conductivity is performed on a pressed pellet. Typically, a pressed pellet is manufactured using a uniaxial or isostatic pressure. When uniaxial pressure is applied to form the pellet, a pressure above 100 MPa, preferentially above 300 Mpa, is applied for a duration of at least 30 seconds. The measurement is done under uniaxial pressure typically between 2 MPa and 200 MPa.

The powder of the present invention may also be characterized by its ageing resistance, notably measured by the conductivity change and the weight change over time.

The conductivity change of the powder of the present invention is preferably less than 50%, as measured according to the following equation (1):

$$Δ C = \frac{{C}_{t 0} - {C}_{t 1}}{{C}_{t 0}} \times 100 \qquad ( 1 )$$

wherein
   ΔC refers to the change in conductivity of the material after a 430-hours exposure in a dry room at 20° C. (dew point less than −35° C.)
   C₁₁ refers to the conductivity measured at time t1, that-is-to-say is after a 430-hours exposure of the material in a dry room at 20° C.
   Cₜ₀ refers to the initial conductivity of the material as measured at time t0, and

Preferably, the conductivity change of the powder is less than 45% or less than 40% as measured according to equation (1).

The weight change of the powder of the present invention is preferably less than 5%, as measured according to the following equation (2):

$$Δ W = \frac{{W}_{t 1} - {W}_{t 0}}{{W}_{t 0}} \times 100 \qquad ( 2 )$$

wherein
   ΔW refers to the change in weight of the material after a 430-hours exposure in a dry room at 20° C.
   Wₜ₁ refers to the weight measured at time t1, that-is-to-say is after a 430-hours exposure of the material in a dry room at 20° C.
   Wₜ₀ refers to the initial weight of the material as measured at time t0.

Preferably, the weight change of the powder is less than 4% or less than 3% as measured according to equation (2).

The present invention also relates to a process for producing the powder described above, comprising the steps of:
a) mixing the starting materials, optionally with high energy, to obtain a paste in a slurry state,
b) drying the paste from step a),
b′) optionally pressing the dried paste from step b) into pellets, and
c) heating the dried paste, e.g. in the form of pellets, to a temperature comprised between 350° C. and 580° C. for a time period of at least 2 hours, for example 4 hours, 6 hours, 8 hours, 10 hours or 12 hours.

In some embodiments, the starting materials of step a) are at least lithium sulfide (Li₂S) and phosphorus sulfide.

In step a), the starting materials, e.g. Li₂S, LiCl and P₂S₅ are mixed together. These starting materials are generally in the powder form to obtain an intimate mixture. The amounts of these starting materials are defined to obtain the targeted stoichiometry. A small excess of Li₂S may be used, in particular to compensate for the potential loss of S during the calcination. The excess of Li₂S may for example be up to an additional 10 wt. % versus the targeted stoichiometry.

Step a) is conveniently performed by wet ball-milling the starting materials in a liquid hydrocarbon. The liquid hydrocarbon is preferably selected in the group consisting of ketones, aliphatic hydrocarbons, cycloaliphatic hydrocarbons, aromatic hydrocarbons and mixtures thereof. Aliphatic hydrocarbons are for instance hexane, heptane, octane or nonane. Cycloaliphatic hydrocarbons are for instance cyclohexane, cyclopentane or cycloheptane. Aromatic hydrocarbons are for instance benzene, toluene, ethylbenzene, xylenes or liquid naphthenes. A convenient liquid hydrocarbon that can be used is xylene or para-xylene.

The weight ratio hydrocarbon/mixture may be between 0.2 to 3.0, for example between 0.4 to 2.0 or between 0.5 to 1.5.

The duration of the milling may be between 1 to 130 hours, for example preferably between 3 and 70 hours or between 6 and 40 hours.

According to step b), the paste from step a) is dried. Drying may be conveniently performed through the evaporation of the liquid hydrocarbon. The evaporation of the liquid hydrocarbon is preferably performed at a temperature between 100° C. and 150° C., more particularly between 105° C. and 135° C. The evaporation may be performed under vacuum. The duration of the evaporation is generally between 1 and 20 hours, more particularly between 2 and 20 hours or between 3 and 7 hours.

At the end of the evaporation, the mixture may comprise some residual hydrocarbon. The amount of residual hydrocarbon is generally such that C content in the mixture is below 5.0 wt. %. The C content may be between 0.01 and 3.0 wt. %.

In step c), the mixture of step b) is heated (or calcined), for example in a rotative oven at a temperature between 350° C. and 580° C., for example between 370° C. and 550° C. or between 39° and 530° C. Step c) is preferably performed under an inert atmosphere, for instance under an atmosphere of N₂ or Ar or H₂S. The duration of step c) is between 1 and 12 hours, more particularly between 2 and 10 hours or between 3 and 7 hours. During step c), the crystallinity of the mixture is improved and as a result, the conductivity is improved.

The rotative oven which may be used to calcined the dried paste from step b) or the pellets from step b′) may be spinning at a rotation speed between 0.5 to 10.0 rpm. The size of the granules may be varied through variation of the speed. The higher the rotation speed, the higher the size of the particles. This means also that the higher the rotation speed, the higher the yield of a composition exhibiting the targeted size.

The process may comprise an additional step d) of sieving the granules to select a specific size range. This operation may be performed manually or automatically. In the conditions used in the laboratory, it is advantageously performed manually.

The present invention also relates to various end-use applications of the powder described herein.

The powder of the present invention may be used to manufacture a solid electrolyte.

The present invention also includes:
a solid electrolyte comprising at least the powder described herein,
an electrochemical device comprising at least the solid electrolyte described herein,
a solid state battery comprising at least the solid electrolyte described herein,
an electrode comprising at least:
   a metal substrate;
   directly adhered onto said metal substrate, at least one layer made of a composition comprising:
   (i) the powder of the present invention;
   (ii) at least one electro-active compound (EAC);
   (iii) optionally at least one lithium ion-conducting material (LiCM) other than the solid material of the invention;
   (iv) optionally at least one electro-conductive material (ECM);
   (v) optionally a lithium salt (LIS);
   (vi) optionally at least one polymeric binding material (P), and
a separator comprising at least:
   the powder of the present invention;
   optionally at least one polymeric binding material (P);
   optionally at least one metal salt, notably a lithium salt;
   optionally at least one plasticizer.

Should the disclosure of any patents, patent applications, and publications which are incorporated herein by reference conflict with the description of the present application to the extent that it may render a term unclear, the present description shall take precedence.

### EXAMPLES

The disclosure will be now described in more detail with reference to the following examples, whose purpose is merely illustrative and not intended to limit the scope of the disclosure.

### Materials

### Inventive Material #1

Inventive materials Li₆PS₅Cl are obtained with a process as follows.

In a first step, 22.7 g of LiCl (Sigma-Aldrich, purity>99%); 59.5 g of P₂S₅(Sigma-Aldrich, 20 purity>99%) and 61.5 g of Li₂S are added into a zirconia jar with ZrO₂ balls (10 mm). 130 g of para-xylene (Sigma-Aldrich, purity>99%, dry) is then added. The tight jar is rapidly sealed to prevent any solvent evaporation. Wet-ball milling is conducted with a planetary ball-mill. After 7 h of milling at 200 rpm, a paste is obtained.

In a second step, the paste is transferred in a dry alumina crucible and dried under dynamic vacuum at 130° C. in an oven to remove the solvent. After 5 hours of drying, the milling balls are separated from the dried powder through sieving at 4 mm.

In a third step, the dried mixture is charged under dry air (less than 300 ppm of water) in an alumina reactor. The reactor is then inserted in a rotative oven and the product is crystallized at 480° C. during 5 hours with a rotation of 1 rpm under N₂ flow (20 L/h). The reactor is then cooled down without rotation.

The final product is in the form of a polydisperse powder with some agglomerates of different sizes. The finished product is obtained by dry homogenization.

### Comparative Material #2

Comparative materials Li₆PS₅Cl are obtained with a process as follows, inspired from the procedure disclosed in Angewandte Chemie, International Edition, 2019, 58, 8681-8686.

In a first step, 0.631 g of LiCl (Sigma-Aldrich, purity>99%); 1.713 g of P₂S₅(Sigma-Aldrich, 20 purity>99%) and 1.713 g of Li₂S are added into a 45 ml zirconia jar with ZrO₂ balls. Ball milling is conducted with a planetary ball-mill. After 2 h of milling at 500 rpm, a powder is obtained.

In a second step, powder is homogenized in a mortar inside an Ar filled glovebox (<1 ppm H₂O, <1 ppm O₂) and then pelletized under 500 MPa to make 6 mm diameter pellets with a mass ranging from 300 to 500 mg. These pellets are sealed under vacuum in carbon covered quartz tubes. The products are crystallised at 550° C. for 7 h with a heating ramp of 0.5° C./min and then cooled to room temperature.

The final product is in the form of densified pellets. The finished product is obtained by dry homogenization with a mortar in the Ar filled glovebox.

### Test Methods

### PSD

The dispersion is prepared for PSD measurement by laser diffraction as follows: 150 mg of powder is put in 50 mL of para-xylene and stirred during at least 5 min. The solution is filtered on a 800 μm siever and introduced in a Malvern Mastersizer 3000. Data are treated with optical model of Fraunhofer.

### In Situ Diffuse Reflectance Infrared Fourier Transform Spectroscopy (DRIFTS)

Diffuse reflectance infrared Fourier transform spectroscopy (DRIFTS) studies were performed on a Bruker FTIR (MIR) Vertex 70 spectrometer. Measurements were conducted using a high-temperature reactor chamber and Praying Mantis diffuse reflectance accessory (Harrick). The reactor chamber is equipped with KBr windows and counts with a type K thermocouple that measures the temperature close to the powder. Different gases can be dosed via mass flow controllers (Bronkhorst). Measurements were carried out at 25° C. and atmospheric pressure under a 25 Nml/min Argon flow used to inertize the analysis chamber and preserve the sample from external moisture. All spectra were recorded using an acquisition time of 1 min and 2 cm⁻¹ spectral resolution. A total of 250 scans were recorded and averaged between 600 and 6000 cm⁻¹. The ratio between the considered groups was calculated by taking the maximum intensity peak in the relevant spectral region i.e. in the 2400 cm⁻¹ to 2570 cm⁻¹ region for the thiol group and in the 1370 cm⁻¹ to 1570 cm⁻¹ region for the carbonate group.

### Conductivity & Electrochemical Impedance Spectroscopy (EIS)

Before the impedance spectroscopy measurements, powder samples were cold-pressed at 500 MPa in an Ar filled glovebox. The conductivity was acquired on pellets done using a uniaxial press operated at 500 MPa. Pelletizing was done using a lab scale uniaxial press in glovebox filled with moisture free Argon atmosphere. Two carbon paper foils (Papyex soft graphite N998 Ref: 496300120050000, 0.2 mm thick from Mersen) are used as current collector. Pellets with their carbon electrodes attached are then loaded into air-tight sample holders and a pressure of 40 MPa is applied on the sample holder for the measurement. The impedance spectra are acquired on a Biologic VMP3 device. The impedance measurements took place at stabilized temperatures at about 24° C. Impedance spectroscopy is acquired in PEIS mode with an amplitude of 20 mV and a range of frequencies from 1 MHz to 1 kHz (25 points per decade and a mean of 50 measurements per frequency point).

### Ageing Resistance

Ageing resistance is measured after a 430-hour exposure of the material in dry room. More precisely, both the change in conductivity of the material and the weight change are measured. Approximately 2 grams of the powder is spread on an aluminium cup and exposed to a dry atmosphere between −45° C. and −50° C. Dew Point (DP). A second empty aluminium cup is placed next to it for control. The monitored bands correspond at 2482 cm⁻¹ and 1445 cm⁻¹ for thiols (−HS) and carbonates groups (CO₃²⁻); respectively.

The evolution of the mass is monitored over time, in order to evaluate the amount of impurities (mainly carbonates and water) that might adsorb on the product surface.

Conductivity change (i.e. loss) is measured according to the following equation (1):

$$Δ C = \frac{{C}_{t 0} - {C}_{t 1}}{{C}_{t 0}} \times 100 \qquad ( 1 )$$

wherein
   ΔC refers to the change in conductivity of the material after a 430-hours exposure in a dry room at 20° C.
   Cₜ₁ refers to the conductivity measured at time t1, that-is-to-say is after a 430-hours exposure of the material in a dry room at 20° C.
   Cₜ₀ refers to the initial conductivity of the material as measured at time t0

Weight change (i.e. increase) is measured according to the following equation (2):

$$Δ W = \frac{{W}_{t 1} - {W}_{t 0}}{{W}_{t 0}} \times 100 \qquad ( 2 )$$

wherein
   ΔW refers to the change in weight of the material after a 430-hours exposure in a dry room at 20° C.
   Wₜ₁ refers to the weight measured at time t1, that-is-to-say is after a 430-hours exposure of the material in a dry room at 20° C.
   Wₜ₀ refers to the initial weight of the material as measured at time t0

### Results

### PSD Results

Inventive Material #1

$$\begin{matrix}{d}_{{10}^{-}} value = 9.4 μm \\ {d}_{{50}^{-}} value = 29.3 μm \\ {d}_{{90}^{-}} value = 65.6 μm\end{matrix}$$

### Comparative Material #2

$$\begin{matrix}{d}_{{10}^{-}} value = 6.8 μm \\ {d}_{{50}^{-}} value = 26.7 μm \\ {d}_{{90}^{-}} value = 103. μm\end{matrix}$$

TABLE 1
Ageing resistance of inventive material #1
Inventive material #1 - Li₆PS₅Cl

| | | | |
|---|---|---|---|
| t (h) | 0 | 6 | 430 |
| Weight gain (wt. %) | nr | +0.26 | +1.02 |
| or Δ W | | | |
| thiol/carbonate surface | 0.47 | 0.46 | 0.29 |
| group ratio | | | |
| σi (mS/cm) at 25° C. | 2.0 | 1.5 | 1.4 |
| ΔC | nr | −25% | −30% |

TABLE 2
Ageing resistance of comparative material #2
Comparative material #2 - Li₆PS₅Cl

| | | | |
|---|---|---|---|
| t (h) | 1 | 6 | 430 |
| Weight gain (wt. %) | nr | +1.3 | +3.4 |
| thiol/carbonate surface | 4.76 | Not | Not measured |
| group ratio | | measured | |
| σi (mS/cm) at 25° C. | 2.4 | 2.0 | 0.7 |
| ΔC | nr | −20.5% | −73.0% |

TABLE 3
Control
Control (empty aluminum cup)

| | | | |
|---|---|---|---|
| t (h) | 1 | 6 | 430 |
| Weight gain (wt. %) | nr | 0 | 0 |

Results compiled in tables 1 and 2 show that inventive material #1 is less sensitive to ageing than comparative material #2 which reveals higher conductivity decrease with ageing, reaching a ΔC of −73.0% after 430 (h) whereas a ΔC of −30.0% only is obtained with the inventive material #1.

1. A powder of solid material particles comprising at least Li, P and S elements, characterized in that a thiol to carbonate surface groups ratio of the particle surface is less than 2, as measured by diffuse reflectance infrared Fourier transform spectroscopy (DRIFTS) on a Bruker FTIR (MIR) Vertex 70 spectrometer (25° C., atmospheric pressure, 25 Nml/min Argon flow), taking into consideration a maximum intensity peak in the 2400 cm⁻¹ to 2570 cm⁻¹ region and a maximum intensity peak in the 1370 cm⁻¹ to 1570 cm⁻¹ region.

2. The powder of claim 1, wherein the solid material is according to formula (I):
LiₐPS_{b}X_{c} (I)
wherein
X represents at least one halogen element;
a represents a number from 2.0 to 7.0;
b represents a number from 3.5 to 6.0; and
c represents a number from 0 to 3.0.

3. The powder of claim 1, wherein the solid material is according to formula (II):
Li₇₋ₓPS₆₋ₓXₓ (II)
wherein:
X represents at least one halogen element selected in the group of F, Cl, Br and I or a combination thereof; and
x represents a positive number from 0.5 to 2.0.

4. The powder of claim 1, wherein the solid material is Li₆PS₅Cl, Li₄P₂S₆, Li₇PS₆, Li₇P₃S₁₁ or Li₃PS₄.

5. The powder of claim 1, presenting:
a d₅₀-value of less than 50 μm,
a d₁₀-value higher than 0.05 μm, and/or
a d₉₀-value of less than 100 μm,
as measured by laser diffraction in para-xylene.

6. The powder of claim 1, presenting an ionic conductivity of at least 1.5 mS/cm, as measured on pressed (500 MPa) pellets by impedance spectroscopy at 25° C.

7. The powder of claim 1, presenting an ageing resistance such that:
its conductivity change is less than 50%, as measured according to the following
$$\begin{matrix}equation ( 1 ) & \\ Δ C = \frac{{C}_{t 0} - {C}_{t 1}}{{C}_{t 0}} \times 100 & ( 1 )\end{matrix}$$
wherein
ΔC refers to the change in conductivity, measured by impedance spectroscopy at 25° C., of the material after a 430-hours exposure in a dry room at 20° C. with a dew point less than −35° C.,
Cₜ₁ refers to the conductivity measured at time t1, that-is-to-say is after a 430-hours exposure of the material in a dry room at 20° C.,
Cₜ₀ refers to the initial conductivity of the material as measured at time t0, and
its weight change is less than 5%, as measured according to the following
$$\begin{matrix}equation ( 2 ) & \\ Δ W = \frac{{W}_{t 1} - {W}_{t 0}}{{W}_{t 0}} \times 100 & ( 2 )\end{matrix}$$
wherein
ΔW refers to the change in weight of the material after a 430-hours exposure in a dry room at 20° C.,
Wₜ₁ refers to the weight measured at time t1, that-is-to-say is after a 430-hours exposure of the material in a dry room at 20° C., and
Wₜ₀ refers to the initial weight of the material as measured at time t0.

8. A method for producing the powder of a claim 1, comprising the steps of:
a) mixing starting materials, optionally with high energy, to obtain a paste in a slurry state,
b) drying the paste from step a),
b′) optionally pressing the dried paste from step b) into pellets, and
c) heating the dried paste, to a temperature comprised between 350° C. and 580° C. for a time period of at least 2 hours.

9. The method of claim 8, wherein the starting materials of step a) are at least lithium sulfide (Li₂S) and phosphorus sulfide.

10. A method comprising manufacturing a solid electrolyte with the powder of claim 1.

11. A solid electrolyte comprising at least the powder of claim 1.

12. An electrochemical device comprising at least the solid electrolyte of claim 11.

13. A solid state battery comprising at least the solid electrolyte of claim 11.

14. An electrode comprising at least:
a metal substrate;
directly adhered onto said metal substrate, at least one layer made of a composition comprising:
(i) the powder of claim 1;
(ii) at least one electro-active compound (EAC);
(iii) optionally at least one lithium ion-conducting material (LiCM) other than the solid material of step (i);
(iv) optionally at least one electro-conductive material (ECM);
(v) optionally a lithium salt (LIS);
(vi) optionally at least one polymeric binding material (P).

15. A separator comprising at least:
the powder of claim 1;
optionally at least one polymeric binding material (P);
optionally at least one metal salt, notably a lithium salt;
optionally at least one plasticizer.
